(19) United States
(12) Patent Application Publication
(10) Pub. No.: US 2019/0070644 A1
(43) Pub. Date: Mar. 7, 2019

(54) INJECTION PROBE CLEANING SYSTEM AND METHOD

(71) Applicant: B3 Systems, Inc., Raleigh, NC (US)

(72) Inventor: Derrick J. Hinkle, Louisburg, NC (US)

(21) Appl. No.: 16/119,455

(22) Filed: Aug. 31, 2018

Related U.S. Application Data
(60) Provisional application No. 62/553,527, filed on Sep. 1, 2017.

(51) Int. Cl. B08B 9/032; B08B 5/02; B05B 15/55

(52) U.S. Cl. CPC B08B 9/0326; B08B 2209/032; B05B 15/55; B08B 5/02

(57) ABSTRACT

A system includes a probe that is configured to inject a material into a process chamber, a gas supply system, a probe cleaning controller that is configured to generate a cleaning start control signal, and a pulsing valve that is coupled to the gas supply system and to the probe and is configured to generate a pulse of gas through the probe responsive to the start cleaning start control signal.

### CROSS REFERENCE TO RELATED APPLICATION

The present application claims priority to U.S. Provisional Patent Application Ser. No. 62/553,527, filed Sep. 1, 2017, the entire content of which is incorporated by reference herein as if set forth in its entirety.

### FIELD OF THE INVENTION

The present invention relates generally to industrial systems involving the injection of a material into a process chamber using a probe and, more particularly, to methods, systems, and apparatus for cleaning such injection probes.

### BACKGROUND

Many industrial, manufacturing, and other types of processes involve the injection of one or more materials into air or gas streams through probes, nozzles, or lances. The injection probes may, however, become plugged or restricted. This can be caused by many factors, such as the type of material(s) being injected, the configuration of the injection system, the conditions of the stream in the process chamber that the material is being injected into, e.g., temperature, moisture, chemical makeup, water droplets, etc.), chemical reactions, or combinations of the foregoing. When an injection probe becomes plugged or restricted, it is typically manually removed and cleaned and then placed back into service. This manual cleaning process may, however, be time consuming and potentially unsafe.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

Some embodiments of the inventive concept provide a system that comprises a probe that is configured to inject a material into a process chamber, a gas supply system, a probe cleaning controller that is configured to generate a cleaning start control signal, and a pulsing valve that is coupled to the gas supply system and to the probe and is configured to generate a pulse of gas through the probe responsive to the start cleaning start control signal.

In other embodiments, the system further comprises a material source reservoir and a material control valve that is coupled to the material source reservoir and to the probe.

In still other embodiments, the probe cleaning controller is further configured to generate an injection stop control signal. The material control valve is configured to block flow of the material from the material source reservoir to the probe the responsive to the injection stop control signal.

In still other embodiments, the probe cleaning controller is further configured to generate an injection start control signal. The material control valve is configured to allow flow of the material from the material source reservoir to the probe responsive to the injection start control signal.

In still other embodiments, the probe cleaning controller is further configured to generate a cleaning stop control signal. The pulsing valve is configured to terminate the pulse of gas through the probe responsive to the cleaning stop control signal.

In still other embodiments, the probe cleaning controller is further configured to generate the cleaning start control signal and the cleaning stop control signal in an alternating sequence. The pulsing valve is configured to generate a plurality of pulses of gas through the probe responsive to the alternating sequence of the cleaning start control signal and the cleaning stop control signal.

In still other embodiments, the system further comprises a sensor associated with the probe that is configured to measure a pressure associated with injection of the material into the process chamber. The probe cleaning controller is configured to generate the cleaning start control signal based on the pressure.

In still other embodiments, the probe cleaning controller is configured to generate the cleaning stop control signal based on the pressure.

In still other embodiments, the system further comprises a sensor associated with the gas supply system that is configured to measure a pressure associated with gas supply system. The probe cleaning controller is configured to generate the cleaning stop control signal based on the pressure.

In still other embodiments, a duration of the pulse is based on a length of the probe, a diameter of the probe, a geometric configuration of the probe, an artificial restriction in the probe, or a type of the gas supply system.

In still other embodiments, the gas supply system comprises a main compressed gas supply source and a header supply tank that is coupled between the main compressed gas supply source and the pulsing valve.

In some embodiments of the inventive concept, a method comprises generating, using a probe cleaning controller, a cleaning start control signal and operating a pulsing valve, which is coupled between a gas supply system and a probe configured to inject a material into a process chamber, to generate a pulse of gas through the probe responsive to the cleaning start control signal.

In further embodiments, the method further comprises generating, using the probe cleaning controller, an injection stop control signal and operating a material control valve, which is coupled to a material source reservoir and to the probe, to block flow of the material from the material source reservoir to the probe responsive to the injection stop control signal.

In still further embodiments, the method further comprises generating. using the probe cleaning controller, an injection start control signal and operating the material control valve to allow flow of the material from the material source reservoir to the probe responsive to the injection start control signal.

In still further embodiments, the method further comprises generating, using the probe cleaning controller, a cleaning stop control signal and operating the pulsing valve to terminate the pulse of gas through the probe responsive to the cleaning stop control signal.

In still further embodiments, the method further comprises generating the cleaning start control signal and the cleaning stop control signal in an alternating sequence and operating the pulsing valve to generate a plurality of pulses of gas through the probe responsive to the alternating sequence of the cleaning start control signal and the cleaning stop control signal.

In still further embodiments, generating the cleaning start control signal comprises generating the cleaning start control signal based on a pressure associated with injection of the material into the process chamber.

In still further embodiments, generating the cleaning stop control signal comprises generating the cleaning stop control signal based on the pressure.

In still further embodiments, generating the cleaning stop control signal comprises generating the cleaning stop control signal based on a pressure associated with the gas supply system.

In still further embodiments, a duration of the pulse is based on a length of the probe, a diameter of the probe, a geometric configuration of the probe, an artificial restriction in the probe, or a type of the gas supply system.

Other methods, systems, computer program products and/or apparatus according to embodiments of the inventive concept will be or become apparent to one with skill in the art upon review of the following drawings and detailed description. It is intended that all such additional methods, systems, computer program products, and/or apparatus be included within this description, be within the scope of the present invention, and be protected by the accompanying claims. It is noted that aspects of the invention described with respect to one embodiment, may be incorporated in a different embodiment although not specifically described relative thereto. That is, all embodiments and/or features of any embodiment can be combined in any way and/or combination.

### BRIEF DESCRIPTION OF THE DRAWINGS

The accompanying drawings, which are included to provide a further understanding of the invention and are incorporated in and constitute a part of this application, illustrate certain embodiment(s) of the invention.

FIGS. 1 and 2 are diagrams that illustrate a system for cleaning an injection probe according to some embodiments of the inventive concept.

FIGS. 3-4 are flowcharts that illustrate operations for cleaning an injection probe according to some embodiments of the inventive concept.

FIG. 5 is a data processing system that may be used to implement the probe cleaning controller of FIGS. 1 and 2 in accordance with some embodiments of the inventive concept.

FIG. 6 is a block diagram that illustrates a software/hardware architecture for use in the probe cleaning controller of FIGS. 1 and 2 in accordance with some embodiments of the inventive concept.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Embodiments are described herein with respect to a gas stream that contains a particulate material. It will be understood that the particulate material is not limited to any type of material and may include, but is not limited to, solid materials, particles, dust, ash, fly ash, and the like.

As described above, injection probes used, for example, to inject one or more materials into a process chamber may become plugged or restricted, which traditionally has resulted in the manual cleaning of the restricted probe. Some embodiments of the inventive concept may provide a system that uses one or more bursts of a compressed gas to clean a probe under the management or supervision of a probe cleaning controller. The compressed gas may be, but is not limited to, any compatible gas, such as air, nitrogen, and the like. In some embodiments, the flow rate of the injection material may stop before the probe is subjected to the pulse of gas. In some embodiments with multiple injection probes, only the injection material flow to the probe being cleaned may be stopped for the cleaning of that probe. Once the injection material flow has been stopped and the probe isolated, a burst of compressed gas may be released down the probe. In some embodiments, multiple bursts of the gas may be used to clean the probe. Once the probe has been cleaned, the injection flow can be restarted through the probe.

The duration of the pulse of the compressed gas may be adjusted based on the application in accordance with various embodiments of the inventive concept. Some factors that may be used for determining the duration of the pulse may include, but are not limited to, the length, diameter, and configuration of the injection probe(s), the source or cause of the pluggage/restriction, and/or the source of compressed gas.

In some embodiments, the pressure of the compressed gas may be monitored after the burst to determine if the probe is clean. For multiple probe systems, the probes may be cleaned on a timed cycle basis. In some embodiments, sensors may be used to monitor the pressure of the probes while injecting source material and cleaning probes on-demand. When the pressure increases to a defined limit, due to restrictions, then the probe may enter into a cleaning cycle.

In some embodiments, if the flow demands of the cleaning system are higher than the supply system can provide on an instantaneous basis, then the system may include one or more localized header supply tanks to store the compressed gas. Then, after a cleaning burst, the header has time to slowly refill before the next cleaning burst.

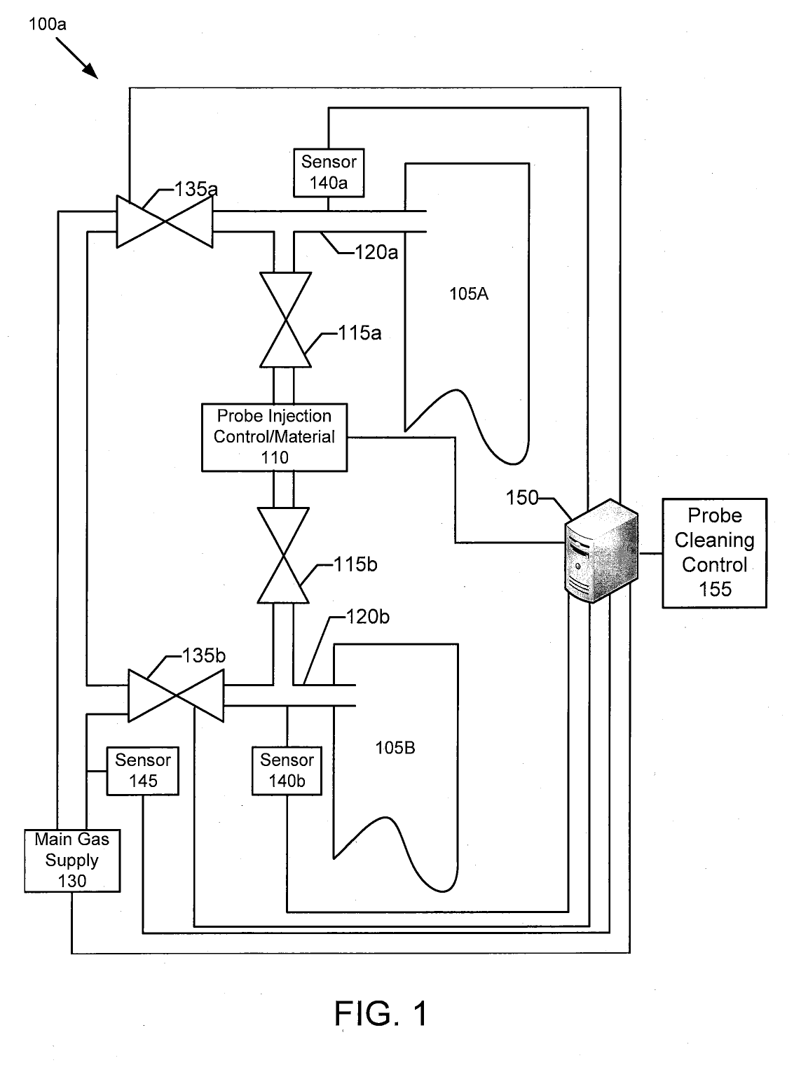

FIG. 1 is a diagram that illustrates a system 100a for cleaning an injection probe according to some embodiments of the inventive concept. As shown in FIG. 1, stacks or ducts 105A and 105B may have a gas stream with particulate matter (PM) flowing therethrough. The system 110a further includes a probe injection control/material system 110 that provides a material source reservoir and a controller for injecting the material into the stacks 105A and/or 105B. The stacks 105A and/or 105B may be viewed generally as process chambers. As shown in FIG. 1, the material may be injected into the stacks 105A and/or 105B through material control valves 115a and/or 115b by way of probes 120a and/or 120b, respectively. As described above, the probes 120a and/or 120b may become plugged or restricted based on one or more of a variety of factors, such as the type of material being injected, the conditions of the gas and/or liquid stream within the stacks 105A and/or 105B, chemical reactions, and the like. Some embodiments of the inventive concept may provide a probe cleaning capability including a main gas supply 130 that is coupled to pulsing valves 135a and 135b, which are coupled to probes 120a and 120b, respectively. The main gas supply 130 may comprise a compressed gas supply source. The gas may be any suitable gas, such as air, nitrogen, and the like, for injection through the probes 120a and/or 120b. The system 100a may further include pressure sensors 140a, 140b, and 145. Pressure sensors 140a and 140b are associated with the probes 120a and 120b, respectively, and are configured to measure the pressure corresponding to flow through the probes 120a and 120b. Similarly, the sensor 145 is associated with the main gas supply 130 and may be configured to measure the pressure corresponding to the flow from the main gas supply 130 to the pulsing valves 135a and/or 135b. A probe cleaning controller 150 includes a probe cleaning control module 155 that is configured to control operation of the pulsing valves 135a, 135b, the main gas supply 130, and may communicate with the probe injection control/material system 110 to control the injection of material into the stacks 105A and/or 105B. The probe injection control/material system 110 and the probe cleaning controller 150 may be implemented as separate controllers/data processing systems or as part of the same controller/data processing system in accordance with various embodiments of the inventive concept. The probe cleaning controller 150 may further communicate with the sensors 140a, 140b, and/or 145 to receive pressure measurements therefrom, which may be used to performing cleaning operations of the probes 120a and/or 120b using the main gas supply 130 by way of the pulsing valves 135a and/or 135b in accordance with various embodiments of the inventive concept.

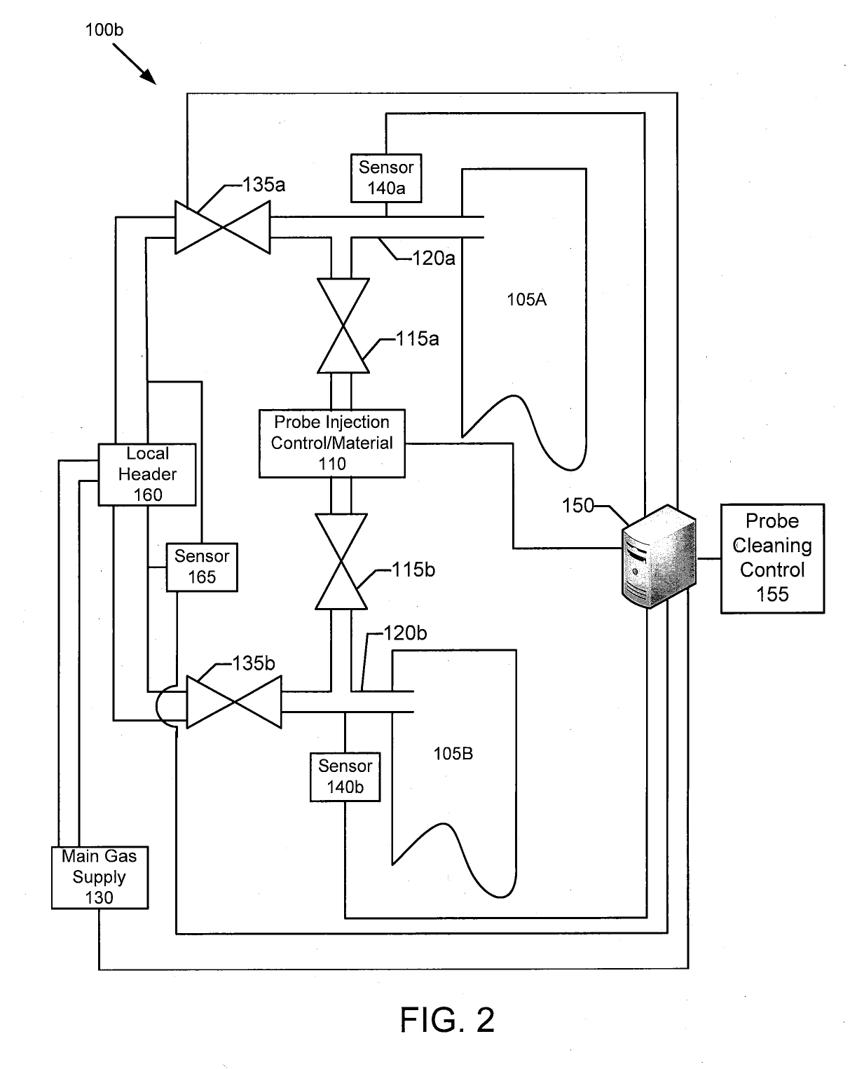

FIG. 2 is a diagram that illustrates a system 100b for cleaning an injection probe according to some embodiments of the inventive concept. The system 100b is similar to that of the system 100a of FIG. 1 with the exception that a local header supply tank 160 is used between the main air gas supply 130 and the pulsing probes 135a and 135b. In some applications, the flow demands of the probe cleaning operations may be higher than what can be provided by the main gas supply 130 on an instantaneous basis. The local header supply tank 160 may store the compressed gas for use in cleaning the probes 120a and/or 120b by way of the pulsing valves 135a and/or 135b, respectively. After a cleaning operation, the local header supply tank 160 may refill from the main gas supply 130 before the next cleaning operation commences. Because of the use of the local header supply tank 160, the sensor 145 of FIG. 1 may be replaced with the sensor 165, which measures the pressure corresponding to the flow from the local header supply tank 160 to the pulsing valves 135a and/or 135b.

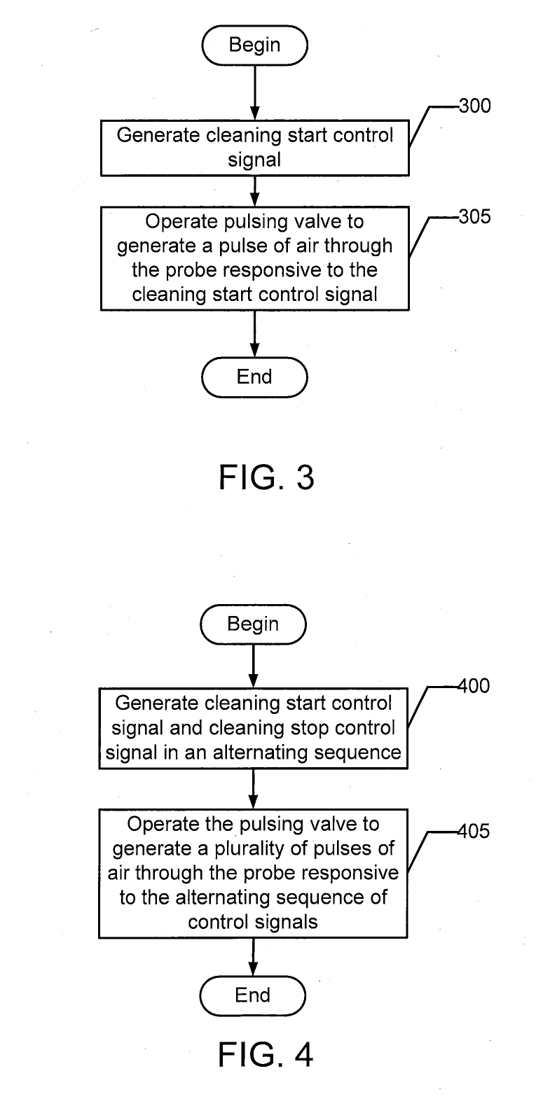

FIGS. 3 and 4 are flowcharts that illustrate operations for cleaning injection probes, such as the probes 120a and/or 120b of FIGS. 1 and 2, using a compressed gas according to some embodiments of the inventive concept. The probe cleaning controller 150 may generate a cleaning start control signal and a cleaning stop control signal for each of the pulsing valves 135a and 135b to open and close, respectively, the pulsing valves 135a and 135b. Similarly, the probe cleaning controller 150 may generate an infection start control signal and an injection stop control signal for the probe injection control/material system 110 to open and close the material control valves 115a and 115b. Thus, the probe cleaning controller 150 may be configured to control operation of the pulsing valves 135a and 135b and material control valves 115a and 115b on an individual basis to control whether compressed gas and/or injection material is injected through the probes 120a and 120b. It will be further understood that while FIGS. 1 and 2 show multiple stacks or process chambers 105A and 105B with each including an injection probe 120a, 120b, respectively, for injecting a material therein and which may be cleaned using a compressed gas as described herein, it will be understood that the inventive concepts are applicable to a single stack or process chamber having a single injection probe associated therewith, a single stack or process chamber having multiple injection probes associated therewith, or many stacks or process chambers each having one or more injection probes associated therewith.

Referring now to FIG. 3, operations begin at block 300 where the probe cleaning controller 150 generates a cleaning start control signal to commence cleaning of one or both of the probes 120a and 120b. In response to the start cleaning response signal, one or both of the pulsing probes 135a and 135b open to allow a burst or pulse of compressed gas from the main gas supply 130 to flow through the corresponding probe 120a and/or 120b to remove blockages or other restrictions that may be inhibiting flow of material through the probe 120a and/or 120b at block 305. In some embodiments, the probe cleaning controller 150 may pause or block injection of material through the probe 120a and/or 120b during the cleaning process by generating an injection stop control signal. The probe injection control/material system 110 may close one or both of the material control valves 115a and 115b to stop flow of the material into the probe 120a and 120b, respectively, in response to the injection stop control signal. In other embodiments, the burst or pulse of compressed gas may be passed through the probe 120a and/or 120b in combination with material from the probe injection control/material system 110. The probe cleaning controller 150 may further generate a cleaning stop control signal to terminate the burst or pulse of compressed gas being passed through the probe 120a and/or 120b. In response to the stop cleaning response signal, one or both of the pulsing probes 135a and 135b close to terminate the burst or pulse of compressed gas from the main gas supply 130 from flowing through the corresponding probe 120a and/or 120b. The duration of the burst or pulse of compressed gas may be based on a variety of factors, in accordance with various embodiments of the inventive concept, including, but not limited to, a length of the injection probe, a diameter of the injection probe, a geometric configuration of the injection probe, the type of artificial restriction creating the blockage in the injection probe, and/or the type of gas supply system. If the injection of material is paused during the cleaning operation using the compressed gas, then the probe cleaning controller 150 may further generate an injection start control signal upon completion of the cleaning operation. The probe injection control/material system 110 may open one or both of the material control valves 115a and 115b to start flow of the material into the probe 120a and 120b, respectively, in response to the injection start control signal.

Referring now to FIG. 4, operations for cleaning injection probes, according to further embodiments of the inventive concept, begin at block 400 where the probe cleaning controller 150 generates at cleaning start control signal and cleaning stop control signal in an alternating sequence. In response to the alternating sequence of cleaning start and stop control signals, one or both of the pulsing probes 135a and 135b open and close to allow a plurality of bursts or pulses of compressed gas from the main gas supply 130 to flow through the corresponding probe 120a and/or 120b to remove blockages or other restrictions that may be inhibiting flow of material through the probe 120a and/or 120b at block 405. The overall duration of the cleaning pulses as well as the duration of the pulses individually may be based on the factors described above with respect to the use of a single cleaning pulse with respect to FIG. 3.

In some embodiments, pressure readings from sensors 140a, 140b, and/or 145 of FIG. 1 and 165 of FIG. 2 may be used as a basis for commencing and/or terminating a cleaning operation of the probes 120a and/or 120b. For example, a limit may be defined and when the pressure within a probe, such as probes 120a and/or 120b exceeds that limit as measured by sensors 140a and/or 140b, then that probe may be identified for a cleaning operation as the increase in pressure may be due to blockage that is restricting the flow of material therethrough. Similarly, sensors 145 and 165, which are associated with the main gas supply 110 and the local header supply tank 160 may be used to measure the pressure during a cleaning operation as the compressed air is flowing through one or both of the injection probes 120a and/or 120b. A limit may be defined such that as the pressure in the piping carrying gas to the probe(s) falls below that limit, then the probe or probes may be deemed to be clean as the probes are more free flowing due to the elimination of a restriction or blockage. In other embodiments, the sensors 140a and/or 140b may be used in similar fashion to the sensors 145 and 160 as a basis for determining when to terminate a cleaning operation. In systems with multiple injection probes, the probes may be scheduled for cleaning on a periodic basis in lieu of or in addition to initiating cleaning based pressure readings from the sensors 140a and/or 140b. As illustrated in FIGS. 1 and 2, multiple probes 120a and 120b may be cleaned in parallel or on an individual basis. Moreover, as shown in FIGS. 1 and 2, a T shaped connection is used between the pulsing valve, the material control valve, and the probe. Other valve configurations may be used in accordance with other embodiments of the inventive concept.

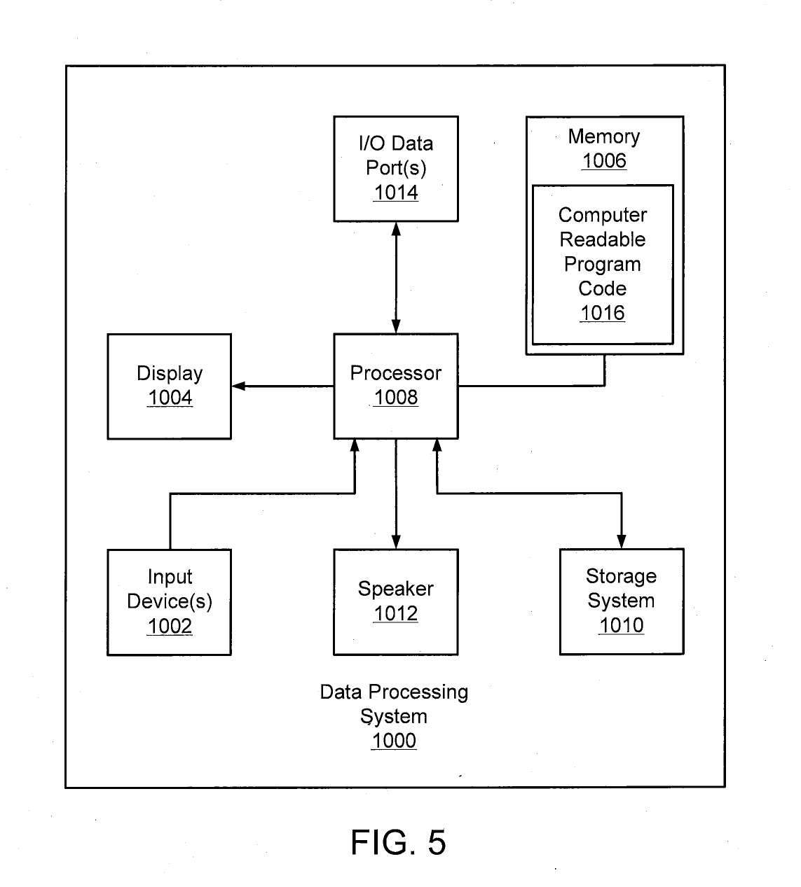

Referring now to FIG. 5, a data processing system 1000 that may be used to implement the probe cleaning controller 150 and/or the probe injection control/material system 110 of FIGS. 1 and 2, in accordance with some embodiments of the inventive concept, comprises input device(s) 1002, such as a keyboard or keypad, a display 1004, and a memory 1006 that communicate with a processor 1008. The data processing system 1000 may further include a storage system 1010, a speaker 1012, and an input/output (I/O) data port(s) 1014 that also communicate with the processor 1008. The processor 1008 may be, for example, a commercially available or custom microprocessor. The storage system 1010 may include removable and/or fixed media, such as floppy disks, ZIP drives, hard disks, or the like, as well as virtual storage, such as a RAMDISK. The I/O data port(s) 1014 may be used to transfer information between the data processing system 1000 and another computer system or a network (e.g., the Internet). These components may be conventional components, such as those used in many conventional computing devices, and their functionality, with respect to conventional operations, is generally known to those skilled in the art. The memory 1006 may be configured with computer readable program code 1016 to manage operation of an injection probe cleaning system in accordance with some embodiments of the inventive concept.

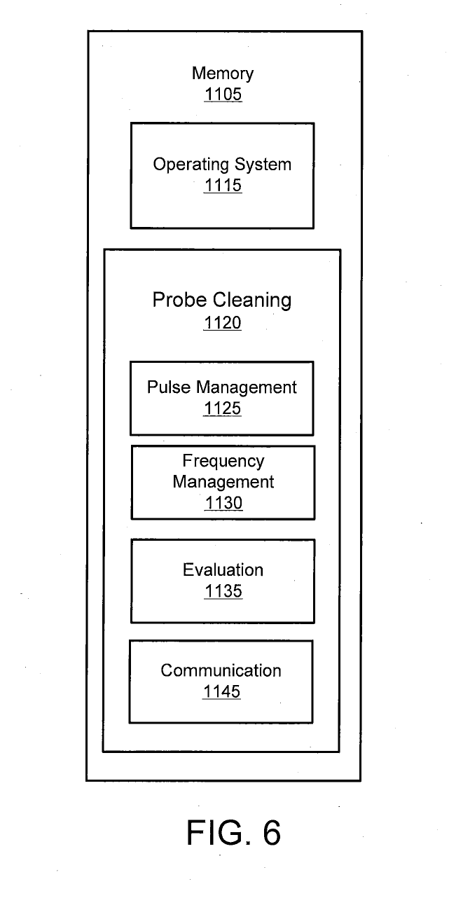

FIG. 6 illustrates a memory 1105 that may be used in embodiments of data processing systems, such as the probe cleaning controller 150 and/or the probe injection control/material system 110 of FIGS. 1 and 2 and the data processing system 1000 of FIG. 5, respectively, to facilitate to facilitate cleaning of injection probes according to some embodiments of the inventive concept. The memory 1105 is representative of the one or more memory devices containing the software and data used for facilitating operations of the probe cleaning controller 150 and/or the probe injection control/material system 110 as described herein. The memory 1105 may include, but is not limited to, the following types of devices: cache, ROM, PROM, EPROM, EEPROM, flash, SRAM, and DRAM.

As shown in FIG. 6, the memory 1105 may contain two or more categories of software and/or data: an operating system 1115 and a probe cleaning module 1120. In particular, the operating system 1115 may manage the data processing system's software and/or hardware resources and may coordinate execution of programs by the processor. The probe cleaning module 1120 may be used to implement the probe cleaning control module 155 of FIGS. 1 and 2 and may comprise a pulse management module 1125, a frequency management module 1130, an evaluation module 1135, and a communication module 1145. In general, probe cleaning module 1120 may be configured to perform one or more of the operations described above with respect to the system diagrams of FIGS. 1 and 2 and the flowcharts of FIGS. 3 and 4.

The pulse management module 1125 may be configured to control the commencement and termination of one or more cleaning pulses through the pulsing valves 135a and 135b along with allowing or pausing the material injection process through the probe injection control/material system 110 and the material control valves 115a and 115b. The frequency management module 1130 may be configured to schedule cleaning of one or more injection probes on a periodic basis and/or based on pressure readings from, for example, sensors 140a and/or 140b. The evaluation module 1135 may be configured to determine when to terminate a cleaning pulse and/or sequence of cleaning pulses and, in some embodiments, to determine whether a probe has been sufficiently cleaned based on pressure readings obtained from sensors associated with the injection probes, e.g., sensors 140a and/or 140b or sensors associated with the compressed gas supply system, e.g., sensors 145 or 165. The communication module 1145 may facilitate communication between the probe cleaning controller 150 and/or the probe injection control/material system 110 and between the sensors 140a, 140b, 145, and 165 and the probe cleaning controller.

Although FIGS. 5 and 6 illustrate hardware/software architectures that may be used in data processing systems, such as the probe cleaning controller 150 and/or the probe injection control/material system 110 of FIGS. 1 and 2 in accordance with some embodiments of the inventive concept, it will be understood that embodiments of the present invention are not limited to such a configuration but is intended to encompass any configuration capable of carrying out operations described herein.

Computer program code for carrying out operations of data processing systems discussed above with respect to FIGS. 1-6 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the probe cleaning controller 150 and/or the probe injection control/material system 110 of FIGS. 1 and 2 and the data processing system 1000 of FIG. 6 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present disclosure of embodiments has been presented for purposes of illustration and description, but is not intended to be exhaustive or limited to the disclosure in the form disclosed. Many variations and modifications can be made to the embodiments without substantially departing from the principles of the present invention. All such variations and modifications are intended to be included herein within the scope of the present invention.

That which is claimed:

1. A system comprising:
a probe that is configured to inject a material into a process chamber;
a gas supply system;
a probe cleaning controller that is configured to generate a cleaning start control signal; and
a pulsing valve that is coupled to the gas supply system and to the probe and is configured to generate a pulse of gas through the probe responsive to the start cleaning start control signal.

2. The system, further comprising:
a material source reservoir; and
a material control valve that is coupled to the material source reservoir and to the probe.

3. The system of claim 2, wherein the probe cleaning controller is further configured to generate an injection stop control signal; and
wherein the material control valve is configured to block flow of the material from the material source reservoir to the probe the responsive to the injection stop control signal.

4. The system of claim 3, wherein the probe cleaning controller is further configured to generate an injection start control signal; and
wherein the material control valve is configured to allow flow of the material from the material source reservoir to the probe responsive to the injection start control signal.

5. The system of claim 3, wherein the probe cleaning controller is further configured to generate a cleaning stop control signal; and
wherein the pulsing valve is configured to terminate the pulse of gas through the probe responsive to the cleaning stop control signal.

6. The system of claim 5, wherein the probe cleaning controller is further configured to generate the cleaning start control signal and the cleaning stop control signal in an alternating sequence; and
wherein the pulsing valve is configured to generate a plurality of pulses of gas through the probe responsive to the alternating sequence of the cleaning start control signal and the cleaning stop control signal.

7. The system of claim 5, wherein the system further comprises:
a sensor associated with the probe that is configured to measure a pressure associated with injection of the material into the process chamber;
wherein the probe cleaning controller is configured to generate the cleaning start control signal based on the pressure.

8. The system of claim 7, wherein the probe cleaning controller is configured to generate the cleaning stop control signal based on the pressure.

9. The system of claim 5, wherein the system further comprises:
a sensor associated with the gas supply system that is configured to measure a pressure associated with gas supply system;
wherein the probe cleaning controller is configured to generate the cleaning stop control signal based on the pressure.

10. The system of claim 1, wherein a duration of the pulse is based on a length of the probe, a diameter of the probe, a geometric configuration of the probe, an artificial restriction in the probe, or a type of the gas supply system.

11. The system of claim 1, wherein the gas supply system comprises:
a main compressed gas supply source; and
a header supply tank that is coupled between the main compressed gas supply source and the pulsing valve.

12. A method, comprising:
generating, using a probe cleaning controller, a cleaning start control signal; and
operating a pulsing valve, which is coupled between a gas supply system and a probe configured to inject a material into a process chamber, to generate a pulse of gas through the probe responsive to the cleaning start control signal.

13. The method of claim 12, further comprising:
generating, using the probe cleaning controller, an injection stop control signal; and
operating a material control valve, which is coupled to a material source reservoir and to the probe, to block flow of the material from the material source reservoir to the probe responsive to the injection stop control signal.

14. The method of claim 13, further comprising:
generating. using the probe cleaning controller, an injection start control signal; and
operating the material control valve to allow flow of the material from the material source reservoir to the probe responsive to the injection start control signal.

15. The method of claim 13, further comprising:
generating, using the probe cleaning controller, a cleaning stop control signal; and
operating the pulsing valve to terminate the pulse of gas through the probe responsive to the cleaning stop control signal.

16. The method of claim 15, further comprising:
generating the cleaning start control signal and the cleaning stop control signal in an alternating sequence; and
operating the pulsing valve to generate a plurality of pulses of gas through the probe responsive to the alternating sequence of the cleaning start control signal and the cleaning stop control signal.

17. The method of claim 15, wherein generating the cleaning start control signal comprises:
generating the cleaning start control signal based on a pressure associated with injection of the material into the process chamber.

18. The method of claim 17, wherein generating the cleaning stop control signal comprises:
generating the cleaning stop control signal based on the pressure.

19. The method of claim 15, wherein generating the cleaning stop control signal comprises:
generating the cleaning stop control signal based on a pressure associated with the gas supply system.

20. The method of claim 12, wherein a duration of the pulse is based on a length of the probe, a diameter of the probe, a geometric configuration of the probe, an artificial restriction in the probe, or a type of the gas supply system.
